(19) United States
(12) Patent Application Publication
(10) Pub. No.: US 2003/0131426 A1
(43) Pub. Date: Jul. 17, 2003

(54) Cleaning device for individual items of cutlery

(76) Inventor: Christof Schulling, Sand (DE)

Correspondence Address: Edwin D. Schindler, Five Hirsch Avenue, P. O. Box 966, Coram, NY, 11727-0966, US

(21) Appl. No.: 10/328,745

(22) Filed: Dec. 23, 2002

Related U.S. Application Data
(63) Continuation-in-part of application No. 09/579,179, filed on May 25, 2000, now abandoned.
Application No. 09/579,179 is a continuation-in-part of application No. 09/117,402, filed on Aug. 25, 1998, now abandoned.
Application No. 09/117,402 is a 371 of international application No. PCT/DE96/02432, filed on Dec. 14, 1996.

(30) Foreign Application Priority Data
Jan. 25, 1996 (DE) 19602499.4

(51) Int. Cl. B08B 1/04; B08B 3/02

(52) U.S. Cl. 15/21.1; 134/199

(57) ABSTRACT

A cleaning device for cleaning individual items of cutlery includes a liquid-proof container having spray nozzles with a supply line within the liquid-proof container through which a cleaning fluid is able to be sprayed, the container having a base with an outlet and an aperture through which an item of cutlery is able to be partially inserted into the container for cleaning. The spray nozzles within the container are, preferably, stationary relative to the item of cutlery being cleaned and directed so that the cleaning fluid strikes the item of cutlery inserted into the container for cleaning with a control device for controlling the supply of the cleaning fluid passing through the supply line to the spray nozzles. There is at least one slot in the top side of the cleaning device, so that the item of cutlery can be stored in close proximity to the liquid-proof container. In particularly preferred embodiments, an ultraviolet irradiation source is provided inside of at least one of the liquid-proof container or at least one slot for irradiating the item of cutlery being cleaned. Alternatively, a heating device may be similarly situated and provided for sterilizing the item of cutlery being cleaned.

### CROSS-REFERENCE TO PRIOR APPLICATIONS

This a continuation-in-part of application Ser. No. 09/579,179, filed May 25, 2000, which is a continuation-in-part of application Ser. No. 09/117,402, filed Aug. 4, 1998, now abandoned, which is the U.S. National Phase application of P.C.T. international patent application No. PCT/DE96/02432, filed Dec. 14, 1996.

### BACKGROUND OF THE INVENTION

1. Technical Field of the Invention

The present invention relates to a cleaning device for cleaning individual items of cutlery, particularly knives, having a liquid-proof container, which has inside spray nozzles having a supply line, through which a cleaning liquid can be sprayed. The container further includes an outlet in its base with the supply line to the nozzles having a valve and/or a pump, along with control means for operating the valve or the pump. The container has an aperture through which an item can be, at least, partially inserted into the container for cleaning, so that preferably part of the item projects above the container during cleaning and the nozzles within the container are so directed for providing that the cleaning fluid strikes the items inserted in the container.

2. Description of the Prior Art

A cleaning nozzle for cleaning individual items of cutlery, especially knives, is disclosed in European Patent Application No. 0,876,124, which derives from the present inventor. This prior art cleaning device essentially comprises a liquid-proof container, which is provided with nozzles inside by means of which a cleaning liquid is sprayed in the direction of an item of cutlery, which can be, at least, partly inserted through a top-side aperture in the container wall. The arrangement facilitates the rapid and hygienically flawless cleaning of soiled knives; flat long items of cutlery, such as cake slicers, as well as spatulas, scrapers or scratchers, both for the medical profession, as well as the trades fields. Water is preferably used as the cleaning liquid, which can also be mixed with cleaning or disinfecting additives. To increase the cleaning performance, the nozzles and their supply lines, and any reservoir for the cleaning liquid, can be heated, particularly because of the ability of water to dissolve fat improves with increased temperature. The cleaning device can also be equipped with a pump by which the cleaning liquid is supplied to the nozzles, or after the liquid has been drained from the inside of the container through an outlet in the base, a reservoir can be put into circulation. The outlet can also be equipped with a sieve to filter out heavy soiling. The aperture on the container is configured so that the item of cutlery to be cleaned can be, at least partly, inserted inside the container, particularly the soiled region as far as the handle shoulder of the knife. This type of cleaning device is preferably used in kitchens, butcher's shops, slaughter houses or comparable food processing companies for performing the cleaning of knives need for processing quickly and without residual viruses or bacteria, which are health hazards.

However, it can be seen as disadvantageous that, in most cases, several differently dimensioned items of cutlery or other tools are necessary for carrying out the respective activities. For example, the knives used in the workplace of the person using them are stored in a separate device from which they are removed, then cleaned and again returned to the device. Consequently, it cannot be ruled out that the item of cutlery is unintentionally returned to the soiled condition and that the storage device, itself, must be subjected to a time-consuming cleaning and disinfecting process. Furthermore, the possibility exists that, owing to carelessness, a cleaned knife is not returned, but is deposited in a different, unsuitable place. Moreover, the removal and depositing of tools in spatially separated devices is laborious and time-consuming.

### SUMMARY OF THE INVENTION

Starting from the state of the art, the present invention has the object of improving a device for the rapid and thorough cleaning of individual items of cutlery to the effect that the temporary or permanent storage of the cleaned items is possible in immediate proximity to the cleaning device with storage being entirely hygienically safe and the items being kept ready for immediate usage.

In accordance with the present invention, the foregoing and related objects are accomplished by the present invention wherein a cleaning device has one or more slot-shaped impressions disposed on its top side, which are configured so that an item of cutlery can be, at least partly, inserted into the cleaning device through its top-side apertures, and the slot-shaped impressions are respectively separated from the interior of the container, which can be impinged by cleaning fluid.

A significant concept concerning the present invention is that slot-shaped impressions are disposed on a device, known per se, for cleaning items of cutlery into which the items, preferably knives, can be at least partly inserted. As a result, the depth and cross-sectional area of the individual impression is freely selectable in the frame of the invention and can be tailored to the respective knife to be stored. The impressions are open upwards and closed with a continuously extended wall outwards and, particularly, toward the interior of the container in which the cleaning takes place. Therefore, in accordance with the present invention, it is irrelevant whether the impressions are configured laterally on, or in, the wall of the container or, preferably, in the case of a detachable lid, are formed on the lid. A simple implementation of the present invention comprises configuring the lid of the container as a deep-drawn plastic molded part during manufacturing, of which the corresponding slot-shaped impressions are already formed. In principle, with the cleaning device of the present invention, a large range of long-extended tools, such as cake slicers, spatulas or screwdrivers can be cleaned. Instead of water, as described above, as the cleaning fluid, organic solvents can also be used for cleaning, e.g., paint brushes soiled with paint residues or medical instruments, which must fulfill stringent requirements with respect to sterility.

An advantage of the present invention is that the items of cutlery are stored in both a clean condition, as well as in immediate spatial proximity to the cleaning device. This eliminates the frequently lengthy search for a tool or item of cutlery, which has been deposited in the wrong place. Further, work routines are accelerated, per se, because removal work, cleaning and re-storage is executed in a single operation.

Preferably, in the case of a detachable lid for the container, which closes off the interior space in which the actual cleaning is performed upwards, the slot-shaped impressions are disposed in the lid itself. The arrangement and the number impressions is selectable in dependency of their respective size and the area of the lid itself. Hence, a parallel arrangement of the slot-impressions is conceivable, by which the same alignment of items is achievable. In a top plan view round lid, a star-shaped arrangement is preferred where the individual slot-shaped impressions are disposed respectively radially outwardly. Thereby, the aperture through which an item of cutlery is insertable partly into the container for cleaning, is either disposed centrally or, likewise, directed radially outwardly, toward the edge offset.

With the use of scrapers or a seal, which are disposed in the region of the aperture, water can be prevented from escaping outside of the container, between the inserted items of cutlery and the lid itself, during the cleaning procedure. Additionally, such means as scrapers or seals, can also remove cleaning liquid still adhering to the items after cleaning for accelerating the drying process and to avoid the formation of scales on the items of cutlery via the evaporation of water droplets. The scrapers used with the present invention are, preferably, configured as replaceable lips, which comprise easily cleanable material, which offers any germs present virtually no opportunity to settle on the cutlery. The scrapers may be made of such materials as, for example, rigid or plasticized PVC, polyethylene or natural rubber. Further, brushes and woven cloth are also conceivable for use as scrapers. To be able to clean items of cutlery or other tools with differing thicknesses or widths, the opposing distance perpendicular to the direction of introduction can be determined changeably, or in a variable manner. This can be accomplished with a hydraulic or pneumatic device or an electric servomotor, which engages the scrapers. In a simple manner, a mechanical notch device can also be used with latches engaging with a grid field or via locking levers for changing the width of the aperture. A preferred solution is to realize the change of distance via a displaceable affixation of the scrapers, wherein at least one scraper is spring-loaded with a bias for effecting closing. An automatic adjustment to the width of the item of cutlery is effected when, at least, one scraper is pushed aside.

To remove heavy soiling or soiling that has dried on the surface of the item of cutlery, it is proposed to equip the cleaning device of the present invention with movable brushes inside of the container, which engage before, during or after the item is sprayed with cleaning liquid and mechanically cleaned. Particularly with revolving brushes, whose rotation axis is oriented either parallel to, or essentially perpendicular to, the direction of insertion, high cleaning performances are achieved. With the triggering device further described below, brushes oriented perpendicularly to the direction of introduction can be controlled, so that only those are activated when the tip of an item of cutlery passes in the direction of the container interior. Possible materials for which the brushes may be made of include, for example, known plastics for the production of comparable cleaning brushes.

To disinfect the item inserted inside the container after cleaning, it is proposed to provide a UV lamp inside the container, which is sealed off in a watertight manner, and whose high energy radiation kills any germs, e.g., bacteria, adhering to the surface of the item of cutlery. Further, to keep the items of cutlery, or other tools, sterile during storage in the slot-shaped impressions, the impressions may also be equipped with UV lamps. To maintain sterility over a longer period of time, such UV lamps may be activated, or controlled, by a timing device at specific time intervals.

A further possibility for sterilizing an item of cutlery includes heating the item, preferably in to at least 100° C. to kill existing germs. This can be achieved via a heating coil inside of the container, which circumscribes the inserted item of cutlery. The duration and temperature of the heating can also be adjusted via the control, or timing, device. Correspondingly, the slot-shaped impressions can also be provided with heating devices on, or in, their walls, which heat and sterilize the inserted item.

In an advantageous and preferred embodiment of the present invention, the cleaning device is equipped with a reservoir for a disinfecting liquid, e.g., pure alcohol, which is sprayed onto the inserted item of cutlery after cleaning. Preferably, to that end, separate pump devices, lines and nozzles are used to avoid mixing with, and pollution by, the ordinary cleaning fluid.

Triggering devices are provided inside the container for an automatic activation of the cleaning device, which register the insertion of an item of cutlery and/or its length to impringe via the control only those nozzles with cleaning liquid, or only to set in rotary motion those brushes in whose effective range cleaning has to actually be performed. As a triggering device, mechanical contacts can be used, which are activated via the introduction of the item of cutlery, or electric or optic devices. Preferred are non-contact light barriers, which are arranged in a substantially vertically extending sequence to register both the insertion, as well as the lengthwise extension of the inserted item.

Preferably, the items of cutlery can be inserted perpendicularly from above, or respectively with the same angle of inclination, into the slot-shaped impressions. Particularly in the case of a cleaning device which is placed in the edge region of the working area, preferred is the introduction inclined from above to be able to withdraw the knife forwards and upwards from the impression.

To store different items of cutlery or tools, it is proposed to provide the slot-shaped impressions with respectively different dimensions with respect to their lengths, widths and depths, i.e., the slot-shaped impressions are respectively adjusted exactly to a specific tool or a knife. Thus, the logical arrangement is improved and the execution of work accelerated, because after a certain period of familiarization, the position of every specific item of cutlery of the user is known.

Other objects and features of the present invention will become apparent when considered in combination with the accompanying drawing figures which illustrate certain preferred embodiments of the present invention. It should, however, be noted that the accompanying drawing figures are intended to illustrate only certain embodiments of the claimed invention and are not intended as a means for defining the limits and scope of the invention.

### BRIEF DESCRIPTION OF THE DRAWING FIGURES

In the drawing, wherein similar reference numerals denote similar features throughout the several views:

FIG. 1 is a cross-sectional view of a cleaning device within the scope of the present invention; and,

FIG. 2 is a top plan view of the lid of the cleaning device.

### DETAILED DESCRIPTION OF THE DRAWING FIGURES AND A PREFERRED EMBODIMENTS

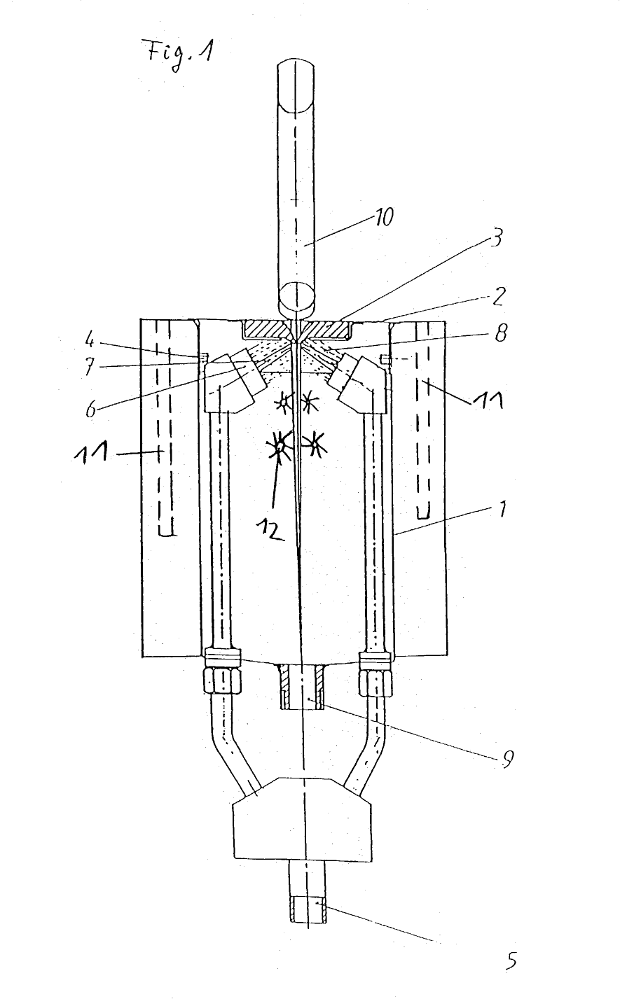

Turning now, in detail, to the preferred embodiment shown in FIG. 1, there is a presented a container 1, which is covered on its top by a lid 2 provided with an aperture therein. Through the aperture, an item of cutlery 10, for example, a knife or a cake slicer, can be introduced as far as the handle piece into an interior space of container 1. Inside, nozzles 6, supply lines 5 leading to nozzles 6 and revolving brushes 12 are disposed. Preferably, nozzles 6 are constructed to remain stationary during a cleaning procedure, while other features, such as brushes 12, are constructed to rotate or other move relative to the item of cutlery 10.

The nozzles 6 can be impinged with a cleaning and/or disinfecting liquid 8 which, in conjunction with a mechanical cleaning of brushes 12, cleans the surface of the cutlery 10, and can thereafter flow away from the interior space of container 1 through an outlet 9. At the aperture, two opposing scrapers 3 are disposed along which the item of cutlery 10 is drawn when removed and while still-adhering residual fluid is removed. With a switch device 7, the insertion of an item of cutlery 10 is registered and the cleaning device is started. To simplify the presentation, the mechanism for changing the opposing distance of the scrapers 3 is not shown. On the sides of container 1, in its wall, slot-shaped impressions 11 are formed into which the items of cutlery 10 can be inserted from above. Slot-shaped impressions 11 allow for the storage of different items of cutlery 10 in immediate proximity to the cleaning device.

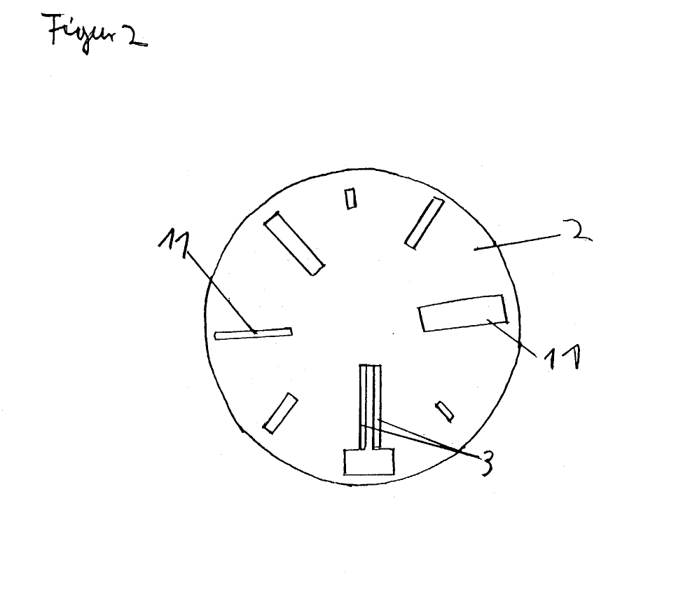

FIG. 2 shows lid 2 of the cleaning device in a top plan view with the preferred star-shaped arrangement of several slot-shaped impressions 11, wherein their respectively longer sides are directed radially outwardly and such impressions 11 are distributed substantially equidistantly across the circumference of lid 2. The aperture for introducing the item of cutlery 10 inside the container is also oriented radially and offset outwardly toward the edge thereof and equipped with scrapers 3. The individual slot-shaped impressions 11, in this preferred embodiment, are configured with differing lengths or widths for being able to be store different items of cutlery 10, such as butcher's knives and filleting knives.

While only several embodiments of the present invention have been shown and described, it will be obvious to those skilled in the art that many modifications may be made to the present invention without departing from the spirit and scope thereof.

What is claimed is:

1. A cleaning device for cleaning individual items of cutlery, comprising:
a liquid-proof container having spray nozzles with a supply line within said liquid-proof container through which a cleaning fluid is able to be sprayed, said liquid-proof container having a base with an outlet in said base, and an aperture through which an item of cutlery is capable of being partially inserted into said liquid-proof container for cleaning, so that a part of the item of cutlery partially inserted into said liquid-proof container projects above an upper surface of said liquid-proof container during cleaning, with said spray nozzles being stationary relative to the item of cutlery being cleaned and directed so that the cleaning fluid strikes the item of cutlery inserted into said liquid-proof container for cleaning;
means for controlling a supply of the cleaning fluid passing through said supply line to said spray nozzles; and,
at least one slot in a top side of said cleaning device, so that the item of cutlery is able to be stored in close proximity to said liquid-proof container, said at least one slot being separated from an interior space of said liquid-proof container.

2. The cleaning device for cleaning individual items of cutlery according to claim 1, wherein said liquid-proof container has a lid with said at least one slot being within said lid.

3. The cleaning device for cleaning individual items of cutlery according to claim 2, wherein said liquid-proof container has a round shape and a plurality of said slots pointing radially outwardly.

4. The cleaning device for cleaning individual items of cutlery according to claim 1, further comprising a plurality of scrapers for scraping the item of cutlery inserted into the aperture within said liquid-proof container for cleaning.

5. The cleaning device for cleaning individual items of cutlery according to claim 4, said plurality of scrapers being perpendicular to the direction of insertion of the item of cutlery through the aperture within said liquid-proof container.

6. The cleaning device for cleaning individual items of cutlery according to claim 1, further comprising movable brushes inside said liquid-proof container for a mechanical cleaning of the item of cutlery being cleaned.

7. The cleaning device for cleaning individual items of cutlery according to claim 6, wherein said movable brushes are revolving brushes.

8. The cleaning device for cleaning individual items of cutlery according to claim 1, wherein said cleaning fluid is a disinfecting liquid.

9. The cleaning device for cleaning individual items of cutlery according to claim 1, further comprising a triggering device within said liquid-proof container for registering an insertion of the item of cutlery to be cleaned and activating said means for controlling a supply of cleaning fluid.

10. The cleaning device for cleaning individual items of cutlery according to claim 1, wherein there are a plurality of said slots with several of said slots having differing dimensions from one another for respectively receiving items of cutlery of differing shapes.

11. The cleaning device for cleaning individual items of cutlery according to claim 1, wherein said means for controlling a supply of the cleaning fluid passing through said supply line to said spray nozzles includes a valve.

12. The cleaning device for cleaning individual items of cutlery according to claim 1, wherein said means for controlling a supply of the cleaning fluid passing through said supply line to said spray nozzles includes pump means.

13. A cleaning device for cleaning individual items of cutlery, comprising:
a liquid-proof container having spray nozzles with a supply line within said liquid-proof container through which a cleaning fluid is able to be sprayed, said liquid-proof container having a base with an outlet in said base, and an aperture through which an item of cutlery is capable of being partially inserted into said liquid-proof container for cleaning, so that a part of the item of cutlery partially inserted into said liquid-proof container projects above an upper surface of said liquid-proof container during cleaning, with said spray nozzles being directed so that the cleaning fluid strikes the item of cutlery inserted into said liquid-proof container for cleaning;
means for controlling a supply of the cleaning fluid passing through said supply line to said spray nozzles;
at least one slot in a top side of said cleaning device, so that the item of cutlery is able to be stored in close proximity to said liquid-proof container, said at least one slot being separated from an interior space of said liquid-proof container; and,
an ultraviolet irradiation source inside of at least one of said liquid-proof container or said at least one slot for irradiating the item of cutlery being cleaned.

14. The cleaning device for cleaning individual items of cutlery according to claim 13, further comprising a timing device for controlling the duration of irradiating the item of cutlery by said ultraviolet irradiation source.

15. The cleaning device for cleaning individual items of cutlery according to claim 14, wherein said timing device is able to selectively turn said ultraviolet irradiation source into an “on” mode and an “off” mode.

16. The cleaning device for cleaning individual items of cutlery according to claim 13, further comprising a plurality of scrapers for scraping the item of cutlery inserted into the aperture within said liquid-proof container for cleaning.

17. The cleaning device for cleaning individual items of cutlery according to claim 16, said plurality of scrapers being perpendicular to the direction of insertion of the item of cutlery through the aperture within said liquid-proof container.

18. The cleaning device for cleaning individual items of cutlery according to claim 13, further comprising a triggering device within said liquid-proof container for registering an insertion of the item of cutlery to be cleaned and activating said means for controlling a supply of cleaning fluid.

19. A cleaning device for cleaning individual items of cutlery, comprising:
a liquid-proof container having spray nozzles with a supply line within said liquid-proof container through which a cleaning fluid is able to be sprayed, said liquid-proof container having a base with an outlet in said base, and an aperture through which an item of cutlery is capable of being partially inserted into said liquid-proof container for cleaning, so that a part of the item of cutlery partially inserted into said liquid-proof container projects above an upper surface of said liquid-proof container during cleaning, with said spray nozzles being directed so that the cleaning fluid strikes the item of cutlery inserted into said liquid-proof container for cleaning;
means for controlling a supply of the cleaning fluid passing through said supply line to said spray nozzles;
at least one slot in a top side of said cleaning device, so that the item of cutlery is able to be stored in close proximity to said liquid-proof container, said at least one slot being separated from an interior space of said liquid-proof container; and,
means for heating the interior space of at least one of said liquid-proof container or said at least one slot.

20. The cleaning device for cleaning individual items of cutlery according to claim 19, wherein said means for heating effects heating of the interior space of at least one of said liquid-proof container or said at least one slot so that the item of cutlery is heated to at least 100° C.

21. The cleaning device for cleaning individual items of cutlery according to claim 19, further comprising a plurality of scrapers for scraping the item of cutlery inserted into the aperture within said liquid-proof container for cleaning.

22. The cleaning device for cleaning individual items of cutlery according to claim 21, said plurality of scrapers being perpendicular to the direction of insertion of the item of cutlery through the aperture within said liquid-proof container.

23. The cleaning device for cleaning individual items of cutlery according to claim 19, further comprising a triggering device within said liquid-proof container for registering an insertion of the item of cutlery to be cleaned and activating said means for controlling a supply of cleaning fluid.
